(19) United States
(12) Patent Application Publication
(10) Pub. No.: US 2025/0390792 A1
(43) Pub. Date: Dec. 25, 2025

(54) COMPUTER-BASED SYSTEMS CONFIGURED FOR EVOLUTIONARY FEATURE SEARCH AND METHODS OF USE THEREOF

(71) Applicant: Capital One Services, LLC, McLean, VA (US)

(72) Inventor: Michael Langford, Plano, TX (US)

(21) Appl. No.: 18/753,687

(22) Filed: Jun. 25, 2024

(51) Int. Cl. G06N 20/00

(52) U.S. Cl. CPC G06N 20/00

(57) ABSTRACT

A method includes receiving a plurality of original features and a ground truth, crossing over the plurality of original features to generate a plurality of current features, generating a subsequent generation of features by: calculating a current importance score of each of the plurality of current features in reference to the ground truth, calculate a parent-pool size, a population size, and a mutation rate, determining the parent-pool size number of current features having the highest current importance scores to identify a plurality of current parent features, crossing over, based on the mutation rate, the plurality of current parent features to generate the population size number of subsequent features, iterating the generating process to generate a plurality of subsequent generations of features until fitness scores of a predetermined number of consecutive generations of features stop rising and adding the parent features to the original features to form an enhanced dataset.

### FIELD OF TECHNOLOGY

The present disclosure generally relates to computer-based systems configured for evolutionary feature search in machine learning.

### BACKGROUND OF TECHNOLOGY

Machine learning algorithms typically rely on processed data in order to work-they can only make predictions from numeric data. This data may be composed of relevant variables, known as “features”. If the calculated features don't clearly expose the predictive signals, no amount of tuning can take a model to the next level. The process for extracting these numeric features is called “feature engineering”.

In many machine learning problems, it is important to perform feature engineering to discover new features from an original dataset which may be more useful for prediction.

Evolutionary feature search is a process of applying transformations to original features and generates new population of features to be crossed over and mutated in successive generations. At the end of the process, top N features that are most relevant to a target variable are returned. This process is typically defined by a few parameters, such as the population size of each generation, the number of top-performing individual features to be selected for breading a next generation, and the mutation rate. Defining these parameters usually requires substantial domain knowledge.

As such, it is desirable to have an automated feature selection to allow a user who is new to the domain to perform the valuable feature engineering.

### SUMMARY OF DESCRIBED SUBJECT MATTER

In at least some embodiments or in combination of at least one other embodiment described herein, the present disclosure may provide an exemplary technically improved computer-based method that may include receiving, by at least one computing device, an original dataset comprising a plurality of original features and a ground truth; crossing over, by the at least one computing device, the plurality of original features to generate a plurality of current features to form a current generation synthesized dataset; generating, by the at least one computing device, at least one subsequent generation synthesized datasets, by: calculating a current importance score of each of the plurality of current features in reference to the ground truth to form a plurality of current importance scores; identifying a current fitness score of the current generation synthesized dataset from the plurality of current importance scores; utilizing a computation resource utilization machine learning model to calculate a plurality of computation resource utilization metrics based on at least one computation cost function of the current generation synthesized dataset, where the plurality of computation resource utilization metrics comprises: a first computation resource utilization metric, identifying a parent-pool size, a second computation resource utilization metric, identifying a population size, and a third computation resource utilization metric, identifying a mutation rate for generating a plurality of subsequent features; determining the parent-pool size number of current features having the highest current importance scores among the plurality of current features to identify a plurality of current parent features; crossing over, based on the mutation rate, the plurality of current parent features to generate the population-size number of subsequent features to form the at least one subsequent generation synthesized dataset; iterating, by the at least one computing device, the generating of the at least one subsequent generation synthesized dataset to generate a plurality of subsequent generation synthesized datasets until a plurality of subsequent fitness scores of a predetermined number of consecutive generations of the subsequent generations synthesized datasets stop rising, where in each iteration of the generating of the at least one subsequent generation synthesized dataset, a subsequent generation synthesized dataset of an immediately preceding iteration becomes a new current generation dataset for a current iteration; and adding the plurality of parent features of the plurality of subsequent generations synthesized datasets to the original dataset to form an enhanced dataset.

In at least some embodiments or in combination of at least one other embodiment described herein, the crossing over may involve multiplying two or more features.

In at least some embodiments or in combination of at least one other embodiment described herein, the current importance score of each of the plurality of current features may be calculated from a correlation coefficient between a feature corresponding to the current importance score and the ground truth.

In at least some embodiments or in combination of at least one other embodiment described herein, the current importance score may be calculated using a gradient boosting model.

In at least some embodiments or in combination of at least one other embodiment described herein, the current fitness score may be identified as a top one of the plurality of current importance scores.

In at least some embodiments or in combination of at least one other embodiment described herein, the computation resource utilization machine learning model may be a contextual bandits model.

In at least some embodiments or in combination of at least one other embodiment described herein, each of the plurality of computation resource utilization metrics may be stored in a variable which may be updated after each iteration.

In at least some embodiments or in combination of at least one other embodiment described herein, the at least one computation cost function of the current generation synthesized dataset may be calculated as an amount of time for a run of the current generation's computation in hours minus a difference between a top synthetic feature's importance score of the current generation and a top synthetic feature's importance score of an immediately preceding generation.

In at least some embodiments or in combination of at least one other embodiment described herein, the computer-based method may further include sorting features in the enhanced dataset according to importance scores of the features.

In at least some embodiments or in combination of at least one other embodiment described herein, the at least one computing device may include a plurality of computing nodes parallelly performing the crossings to generate the plurality of current features.

### BRIEF DESCRIPTION OF THE DRAWINGS

Various embodiments of the present disclosure can be further explained with reference to the attached drawings, wherein like structures are referred to by like numerals throughout the several views. The drawings shown are not necessarily to scale, with emphasis instead generally being placed upon illustrating the principles of the present disclosure. Therefore, specific structural and functional details disclosed herein are not to be interpreted as limiting, but merely as a representative basis for teaching one skilled in the art to variously employ one or more illustrative embodiments.

FIG. 1 is a block diagram illustrating an exemplary evolutionary feature search process in accordance with one or more embodiments of the present disclosure.

FIG. 2 is a block diagram illustrating a feature crossing over scheme in accordance with one or more embodiment of the present disclosure.

FIG. 3 is a flowchart illustrating the exemplary evolutionary feature search process for generating the synthesized datasets shown in FIG. 1 in accordance with one or more embodiment of the present disclosure.

FIG. 4 is a flowchart illustrating an exemplary process for generating a subsequent generation synthesized dataset shown in FIG. 3 in accordance with one or more embodiment of the present disclosure.

FIG. 5 is a flowchart illustrating an exemplary process for determining if generating the subsequent generation synthesized dataset is still rewarding shown in FIG. 3 in accordance with one or more embodiment of the present disclosure.

FIG. 6 is a block diagram of an exemplary computing system that may implement the methods described herein.

### DETAILED DESCRIPTION

Various detailed embodiments of the present disclosure, taken in conjunction with the accompanying figures, are disclosed herein; however, it is to be understood that the disclosed embodiments are merely illustrative. In addition, each of the examples given in connection with the various embodiments of the present disclosure is intended to be illustrative, and not restrictive.

Throughout the specification, the following terms take the meanings explicitly associated herein, unless the context clearly dictates otherwise. The phrases “in one embodiment” and “in some embodiments” as used herein do not necessarily refer to the same embodiment(s), though it may. Furthermore, the phrases “in another embodiment” and “in some other embodiments” as used herein do not necessarily refer to a different embodiment, although it may. Thus, as described below, various embodiments may be readily combined, without departing from the scope or spirit of the present disclosure.

In addition, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the terms “and” and “or” may be used interchangeably to refer to a set of items in both the conjunctive and disjunctive in order to encompass the full description of combinations and alternatives of the items. By way of example, a set of items may be listed with the disjunctive “or”, or with the conjunction “and.” In either case, the set is to be interpreted as meaning each of the items singularly as alternatives, as well as any combination of the listed items.

In data science, data is structured and relational, usually presented as a set of tables with relational links. The data captures some aspect of human interactions with a complex system. The data science attempts to predict some aspect of human behavior, decisions, or activities (e.g., to predict whether a customer will buy again after a sale).

Given a prediction problem, a data scientist must first form variables, otherwise known as features. The data scientist may start by using some static fields (e.g. gender, age, etc.) from the tables as existing features, then synthesize new features (e.g. “percentile of a certain feature”) from the existing features.

In some instances, machine learning algorithms may rely on numerical data to make predictions. In some instances, the numerical data may be composed of relevant features. The embodiments disclosed herein provide technical solutions and technical improvements that overcome technical problems, drawbacks and/or deficiencies in the technical fields arising, for example, without limitation, when the calculated features don't expose the predictive signals in sufficient extent that may make challenging to train a model to increase its predictive quality.

As explained in more detail, herein, technical solutions and technical improvements herein includes aspects of evolutionary feature search with automatically determined parameters for synthesizing each generation of features. Based on such technical features, further technical benefits become available to users and operators of these systems and methods. Moreover, various practical applications of the disclosed technology are also described, which provide further practical benefits to users and operators that are also new and useful improvements in the art.

In at least some embodiments or in combination of at least one other embodiment described herein, the present disclosure is directed to evolutionary feature search by crossing over features to generate new ones. In at least some embodiments or in combination of at least one other embodiment described herein, the evolutionary feature search describes at least one illustrative method, without limitation, which may include receiving a plurality of original features and a ground truth, crossing over the plurality of original features to generate a plurality of current features, generating a subsequent generation of features by: calculating a current importance score of each of the plurality of current features in reference to the ground truth, calculate a parent-pool size, a population size, and a mutation rate, determining the parent-pool size number of current features having the highest current importance scores to identify a plurality of current parent features, crossing over, based on the mutation rate, the plurality of current parent features to generate the population-size number of subsequent features, iterating the generating process to generate a plurality of subsequent generations of features until a plurality of subsequent fitness scores of a predetermined number of consecutive generations of features stop rising.

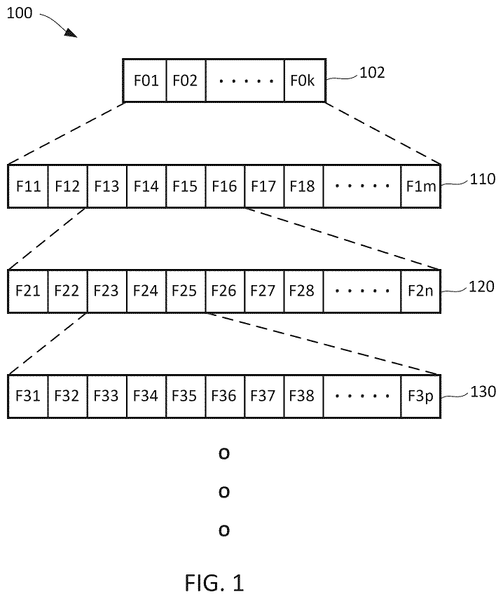

FIG. 1 is a block diagram illustrating an evolutionary feature search process 100 in accordance with one or more embodiments of the present disclosure. In at least some embodiments or in combination of at least one other embodiment described herein, original dataset 102 having k number of original features, F01, F02, . . . . F0k, may be provided by a user who intend to discover new features beyond these original features. The user may also provide a ground truth (not shown) to evolutionary feature search process 100. The term “ground truth” used herein refers to an ideal expected result used in statistical models to prove or disprove research hypotheses. For example, in testing a stereo vision system to see how well it can estimate 3D positions. A “ground truth” can be the positions given by a laser rangefinder which is known to be much more accurate than a camera system. Another example is supervised learning, such as Bayesian spam filtering. In this system, ground truth of messages is used to train an algorithm which is manually taught the differences between spam and non-spam.

In at least some embodiments or in combination of at least one other embodiment described herein, evolutionary feature search process 100 may create m number of features, F11, F12, . . . , F1m, to form a first generation synthesized dataset 110 by crossing over original features, F01, F02, . . . . F0k, in original dataset 102. In an embodiment, the number “m” is a current value of a population size variable. For the first generation synthesized dataset 110, the population size variable may be at a default value determined by the user or provided by evolutionary feature search process 100 itself. Similarly, mutation rate of the first generation synthesized dataset 110 may also be a current value of a mutation rate variable. For the first generation synthesized dataset 110, the mutation rate variable may also be at a default value which can be determined by the user or provided by evolutionary feature search process 100 itself.

However, not all synthesized features provide significant predictive power or is useful, therefore the synthesized features need to be ranked, thus selectively chosen based on their contribution to a final prediction. In at least some embodiments or in combination of at least one other embodiment described herein, feature importance scores may be used to determine the relative importance of each feature in a dataset when selecting important features or building a predictive model. The higher the score for a feature, the larger effect it has on the model to predict a certain variable.

In at least some embodiments or in combination of at least one other embodiment described herein, evolutionary feature search process 100 may calculate an importance score of each synthesized feature (F11, F12, . . . , or F1m) in reference to the ground truth. The importance score of a feature may define how important this feature is in making a prediction, thus may be a good indication of whether this feature may actually be important.

In at least some embodiments or in combination of at least one other embodiment described herein, model-agnostic feature importance methods may be used. Model-agnostic feature importance is a type of feature importance that is not specific to any particular machine learning model or algorithm. Instead, it is a technique that can be applied to any model, regardless of its underlying architecture or complexity.

Correlation criteria may be used as a model-agnostic feature importance method by calculating a correlation coefficient, such as Pearson's correlation coefficient, between each feature and a target variable (the ground truth). The Pearson's correlation coefficient ranges between −1 and 1. A correlation coefficient of 1 means that the two variables may be perfectly positively correlated, a coefficient of −1 means that they may be perfectly negatively correlated and 0 means that they may be not correlated.

Permutation importance is another model-agnostic method. It involves randomly shuffling the values of a single feature and measuring the impact on model performance (e.g., accuracy and dice coefficient of the set of retrieved items and the set of relevant items). The larger the drop in performance, the more important the feature. Libraries like eli5 or sklearn can be used to compute permutation importance.

The calculation of feature importance scores may depend on a machine learning model that is used. In at least some embodiments or in combination of at least one other embodiment described herein, gradient boosting models (GBM) may be used for calculating feature importance scores. These models inherently calculate feature importance during training. The importance score is based on how often a feature is used for splitting nodes and how much it improves the model's performance. The feature importance scores may be accessed directly from the trained model.

In at least some embodiments or in combination of at least one other embodiment described herein, the importance score of a synthesized feature may be compared with a top feature importance value in the original dataset 102 to make sure that the synthesized features may be more useful than any feature in the original dataset 102. The importance scores of the synthesized features may be normalized by dividing each by the top feature importance value in the original dataset 102.

In at least some embodiments or in combination of at least one other embodiment described herein, evolutionary feature search process 100 may also track a fitness score for each generation synthesized dataset 110, etc. In one embodiment, the fitness score of a particular generation synthesized dataset may be assigned to be the top importance score of the features in that particular generation synthesized dataset. In another embodiment, the fitness score of a particular generation synthesized dataset may be assigned to be the top importance score of the features in that particular generation synthesized dataset or a top fitness score of a previous generation, whichever is greater.

For example, there are three original features: humidity, UV index, and temperature, plus an additional feature which is a result of multiplying together the three original features. The additional feature is to be evaluated. Then a total of four features against a target (whether we can play tennis today) are used to train the gradient boosted model. The user tell the model to figure it out whether we play tennis today based on the four columns and the ground truth. As a classic supervised machine learning problem, the model may be able to figure it out based on the values in these columns. For instance, the importance scores for UV, temperature, humidity and the additional feature are found to be 0.3, 0.6, 0.9 and 0.96, respectively. This tells the user how much more or less important this additional evaluated feature may be than top feature from the original features. If the importance scores of the evaluated feature and the top feature of original set are exactly the same, the evaluated feature may be skipped.

As shown in FIG. 1, evolutionary feature search process 100 exemplarily identifies four features F13, F14, F15 and F16 as having the highest importance scores to be parent features for further crossing over. The number of top-performing (most important) individual features equals to the value of a parent-pool size variable. For the first generation synthesized dataset 110, the parent-pool size variable may be at a default value either determined by the user or provided by evolutionary feature search process 100 itself.

As shown in FIG. 1, features F13, F14, F15 and F16 are used as parents to synthesize, with a certain mutation rate, a second generation synthesized dataset 120 which includes n number of features F21, F22, F23, F24, F25, F26, F27, F28, . . . , F2n, where n is a current value of the population size variable. The mutation rate, obtained from a mutation rate variable, controls the rate of change in the synthesized features from the parent features.

In at least some embodiments or in combination of at least one other embodiment described herein, evolutionary feature search process 100 calculates a cost function of the current generation's computation as the amount of time for a run of the current generation's computation in hours minus a difference between the top synthetic feature's importance score of the current generation and the top synthetic feature's importance score of an immediately preceding generation. This is chosen to reward the improvement in synthetic feature importance values and penalize lengthy computation time which can be due to choosing a large population size.

In at least some embodiments or in combination of at least one other embodiment described herein, evolutionary feature search process 100 updates the population size, mutation-rate and parent-pool size variable after each generation of synthesized dataset. For example, a contextual bandits model can be used to determine values of these variable from the cost function.

The contextual bandit model is a machine learning framework that uses additional side information (or context) to aid real world decision-making. In the contextual bandit problem, a learner repeatedly observes a context, chooses an action, and observes a loss/cost/reward for the chosen action only. With contextual bandit, a learning algorithm can test out different actions and automatically learn which one has the most rewarding outcome for a given situation. Contextual bandits allow intelligent decision-making in dynamic environments, adapting to changing contexts and maximizing rewards.

In at least some embodiments or in combination of at least one other embodiment described herein, immediately preceding generation's population size, mutation-rate and parent-pool size provide context to the contextual bandit model, and the immediately preceding and current generation's cost functions provide effectiveness information. Based on these information, the contextual bandit model decides next generation's population size, mutation-rate and parent-pool size.

Referring again to FIG. 1, three most important features, F23, F24 and F25, from the second generation synthesized dataset 120 are chosen as parent features to synthesize a third generation synthesized dataset 130 through a crossing over process. Evolutionary feature search process 100 can go on for many generations. However, for practical purposes, it must have an end. In an embodiment, if the fitness score increases at least once in the past five generations of dataset including the original one (the fitness score for the original dataset may be exemplarily set to zero), evolutionary feature search process 100 continues. Otherwise, evolutionary feature search process 100 terminates and collects the parent features from each generation synthesized dataset plus the original features as an enhanced dataset for evolutionary feature search process 100. In other embodiments, the number of generations for evaluating the increase of fitness score can be a different integer set by the user.

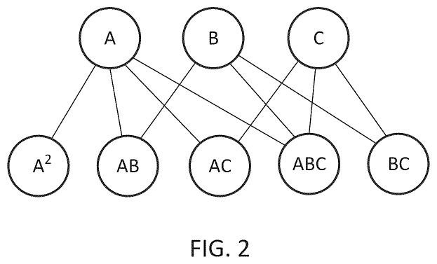

FIG. 2 is a block diagram illustrating a feature crossing over scheme in accordance with at least some embodiments of the present disclosure. In at least some embodiments or in combination of at least one other embodiment described herein, a feature cross is a synthetic feature created by combining two or more existing features. It involves multiplying (crossing) the values of the existing features to create a new one. Feature crosses are commonly used in machine learning to capture interactions between different variables, which can enhance model performance.

For example, suppose there are two features, “age” and “income”. Instead of using them individually, a feature cross can be created by multiplying the age and income values. This new feature, “income-times-age”, represents the interaction between age and income. It can capture patterns that neither age nor income alone can reveal.

Feature crosses can be more complex, involving multiple features and different mathematical operations. They allow models to learn non-linear relationships and interactions between variables, leading to better predictive power.

As shown in FIG. 2, each circle represents a feature. Features A, B and C are parent features; and features A², AB, AC, ABC and BC are resultant features of the crossing over scheme. Feature A² is created by a square of feature A value. Feature AB is created by a multiplication of feature A value and feature B value. Feature AC is created by a multiplication of feature A value and feature C value. Feature ABC is created by a multiplication of feature A value, feature B value and feature C value. Feature BC is created by a multiplication of feature B value and feature C value.

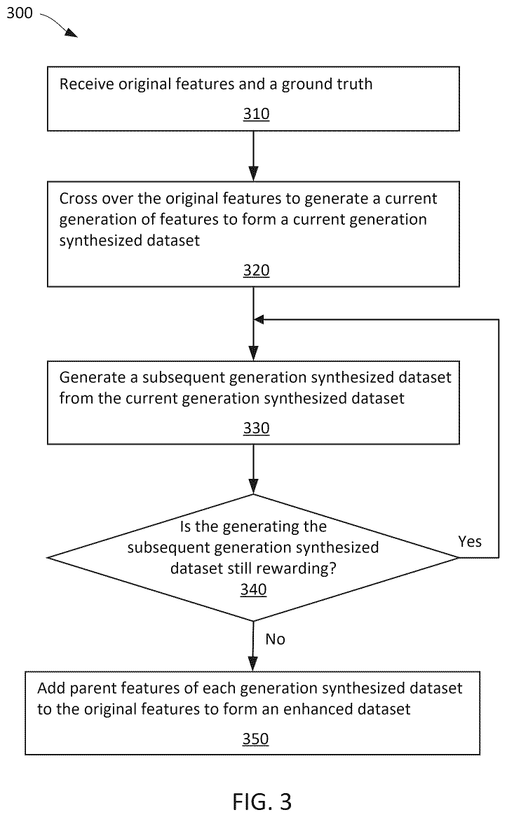

FIG. 3 is a flowchart illustrating an evolutionary feature search process 300 for generating the synthesized datasets 110-130 shown in FIG. 1. Evolutionary feature search process 300 begins with receiving original dataset 102 and the ground truth in block 310. Features in original dataset 102 may be crossed over to generate a current generation of features to form a current generation synthesized dataset 110 in block 320. Current generation synthesized dataset 110 may then be used to generate a subsequent generation synthesized dataset 120 in block 330. Evolutionary feature search process 300 iterates the feature crossing over process (generating subsequent generation synthesized dataset 130, etc.) until the process becomes not rewarding determined in block 340. Once the iteration of blocks 330 and 340 is terminated, evolutionary feature search process 300 adds the parent features (top performers) of each generation synthesized dataset to the original features to form an enhanced dataset in block 350. In at least some embodiments or in combination of at least one other embodiment described herein, the features in the enhanced dataset may be sorted by their importance scores.

In at least some embodiments or in combination of at least one other embodiment described herein, the parent features have higher importance scores than the original features, therefore, adding the parent features to the original features not only expands the number of features in the enhanced dataset but also enhances its predictive power.

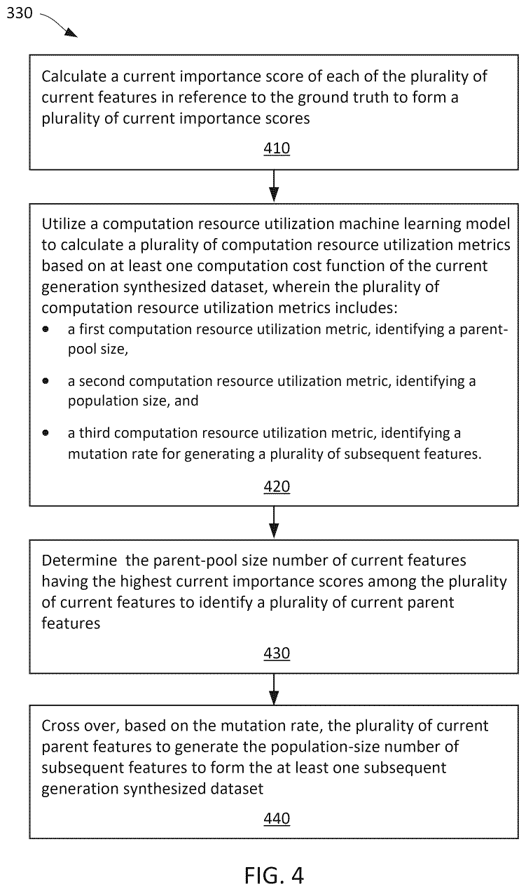

FIG. 4 is a flowchart illustrating an exemplary process 330 for generating a subsequent generation synthesized dataset shown in FIG. 3. In at least some embodiments or in combination of at least one other embodiment described herein, process 330 begins with calculating a current importance score of each of the plurality of current features in reference to the ground truth to form a plurality of current importance scores in block 410. In an embodiment, the importance scores may be obtained by calculating a correlation coefficient between each feature and the ground truth. In another embodiment, the importance scores may be calculated using a gradient boosting model (GBM).

Referring again to FIG. 4, process 330 then utilizes a computation resource utilization machine learning model, in block 420, to calculate a plurality of computation resource utilization metrics based on at least one computation cost function of the current generation synthesized dataset, wherein the plurality of computation resource utilization metrics includes:
a first computation resource utilization metric, identifying a parent-pool size,
a second computation resource utilization metric, identifying a population size, and
a third computation resource utilization metric, identifying a mutation rate for generating a plurality of subsequent features.

In at least some embodiments or in combination of at least one other embodiment described herein, the computation cost function of the current generation may be calculated as the amount of computing time in hours spent in running the current generation's synthesizing operation in minus a difference between the top synthetic feature's importance score of the current generation and that of the immediately preceding generation.

In at least some embodiments or in combination of at least one other embodiment described herein, the computation resource utilization machine learning model may be a contextual bandit model with immediately preceding generation's population size, mutation-rate and parent-pool size provide context to the contextual bandit model, and the previous and current generation's cost functions provide effectiveness information.

Referring again to FIG. 4, process 330 determines, in block 430, the parent-pool size number of current features having the highest current importance scores among the plurality of current features to identify a plurality of current parent features. In block 440, process 330 crosses over, based on the mutation rate, the plurality of current parent features to generate the population-size number of subsequent features to form the at least one subsequent generation synthesized dataset shown in block 330 of FIG. 3.

Referring again to FIG. 3, when evolutionary feature search process 300 begins a new iteration of block 330, a subsequent generation synthesized dataset of an immediately preceding iteration becomes a current generation synthesized dataset for the new iteration.

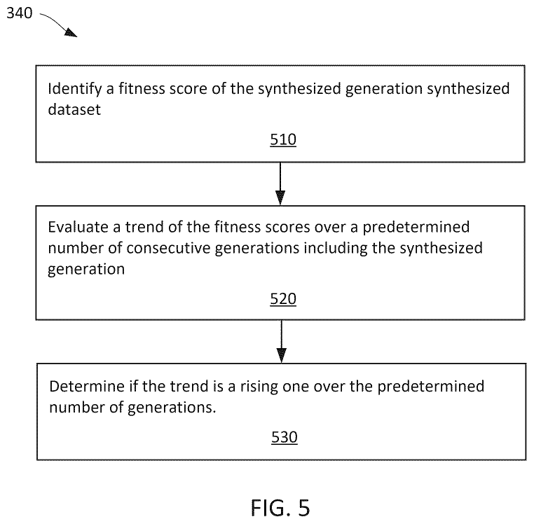

FIG. 5 is a flowchart illustrating an exemplary process 340 for determining whether generating the subsequent generation synthesized dataset is still rewarding shown in block 340 of FIG. 3. In at least some embodiments or in combination of at least one other embodiment described herein, process 340 begins with identifying a fitness score of the synthesized generation synthesized dataset in block 510. In an embodiment, the fitness score may be assigned to be the top importance score of the features in the synthesized generation synthesized dataset. In block 520, process 340 evaluates a trend of the fitness scores over a predetermined number of consecutive generations including the synthesized generation. In an embodiment, the predetermined number may be exemplarily set at 5 by the user. The user can adjust the predetermined number by observing results of evolutionary feature search process 300.

In block 530, process 340 determines if the trend is a rising one over the predetermined number of generations. If the trend demonstrates at least one rise over the predetermined number of fitness scores, block 340 as shown in FIG. 3 determines that generating the subsequent generation synthesized dataset is still rewarding, thus the iteration can continue. For example, assume first through fourth generations' fitness scores are 5, 4, 3 and 4, respectively, and the predetermined number of previous consecutive generations is 3, as fourth generation's fitness score (4) is higher than that of third generation (3), the trend is regarded as a rising one.

If the trend demonstrates a straight downward change over the predetermined number of fitness scores, block 340 as shown in FIG. 3 determines that generating the subsequent generation synthesized dataset is not rewarding, thus terminates the iteration.

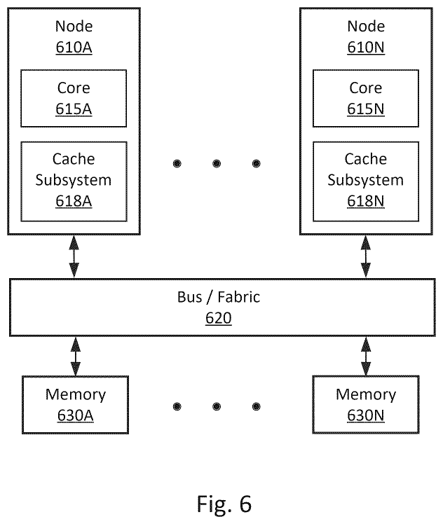

FIG. 6 is a block diagram of an exemplary computing system that implements the methods described herein. In at least some embodiments or in combination of at least one other embodiment described herein, the computing system includes multiple nodes 610A-N for performing one or more computing tasks, with the number of nodes per system varying from implementation to implementation. Each node 610A-N can include any number of cores 615A-N, respectively, with the number of cores varying according to the implementation and from node to node. Each core 615A-N includes at least one computing device, such as a CPU and/or GPU (not shown). Each node 610A-N also includes a corresponding cache subsystem 618A-N, respectively. Each cache subsystem 618A-N can include any number of cache levels and any type of cache hierarchical structure. In an implementation, cache subsystem 618A is locally accessible by core 615A as well as accessible by other nodes 610B (not shown)—110N through a bus/fabric 620.

In one embodiment, each node 610A-N is coupled to a corresponding memory 630A-N, respectively, through the bus/fabric 620. In an implementation, contents stored in memory 630A-N are first loaded to cache subsystem 618A-N for execution by core 615A-N. Each memory 630A-N is accessible by any one of node 610A-N. Many other devices or subsystems can be connected to the computing system shown in FIG. 6.

The computing system can also employ any number of software, firmware, and/or hardware configurations. For example, one or more of the example embodiments disclosed herein can be encoded as a computer program (also referred to as computer software, software applications, computer-readable instructions, and/or computer control logic) on a computer-readable medium.

The term “computer-readable medium,” as used herein, can generally refer to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

One of the example embodiments can be the feature crossing-over shown in FIG. 2. In order to increase processing efficiency, multiple feature creation by crossing over can be parallelly performed by nodes 610A-N separately. For example, feature AB is created by node 610A while feature BC is created by node 610N.

Another one of the example embodiments can be calculating the importance scores of synthesized features shown in FIG. 3. The synthesized features can be simultaneously provided to multiple nodes 610A-N each running an importance score calculation. Such parallel calculations can reduce overall compute time.

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Computer-related systems, computer systems, and systems, as used herein, include any combination of hardware and software. Examples of software may include software components, operating system software, middleware, firmware, software modules, routines, subroutines, functions, methods, procedures, software interfaces, application program interfaces (API), instruction sets, computer code, computer code segments, words, values, symbols, or any combination thereof. Determining whether an embodiment may be implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, etc.).

In some embodiments, one or more of exemplary inventive computer-based systems/platforms, exemplary inventive computer-based devices, and/or exemplary inventive computer-based components of the present disclosure may include or be incorporated, partially or entirely into at least one personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

In some embodiments, as detailed herein, one or more of exemplary inventive computer-based systems/platforms, exemplary inventive computer-based devices, and/or exemplary inventive computer-based components of the present disclosure may be implemented across one or more of various computer platforms such as, but not limited to: (1) FreeBSD, NetBSD, OpenBSD; (2) Linux; (3) Microsoft Windows; (4) OS X (MacOS); (5) MacOS 11; (6) Solaris; (7) Android; (8) iOS; (9) Embedded Linux; (10) Tizen; (11) WebOS; (12) IBM i; (13) IBM AIX; (14) Binary Runtime Environment for Wireless (BREW); (15) Cocoa (API); (16) Cocoa Touch; (17) Java Platforms; (18) JavaFX; (19) JavaFX Mobile; (20) Microsoft DirectX; (21).NET Framework; (22) Silverlight; (23) Open Web Platform; (24) Oracle Database; (25) Qt; (26) Eclipse Rich Client Platform; (27) SAP NetWeaver; (28) Smartface; and/or (29) Windows Runtime.

In some embodiments, exemplary inventive computer-based systems/platforms, exemplary inventive computer-based devices, and/or exemplary inventive computer-based components of the present disclosure may be configured to utilize hardwired circuitry that may be used in place of or in combination with software instructions to implement features consistent with principles of the disclosure. Thus, implementations consistent with principles of the disclosure are not limited to any specific combination of hardware circuitry and software. For example, various embodiments may be embodied in many different ways as a software component such as, without limitation, a stand-alone software package, a combination of software packages, or it may be a software package incorporated as a “tool” in a larger software product.

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

As used herein, the terms “cloud,” “Internet cloud,” “cloud computing,” “cloud architecture,” and similar terms correspond to at least one of the following: (1) a large number of computers connected through a real-time communication network (e.g., Internet); (2) providing the ability to run a program or application on many connected computers (e.g., physical machines, virtual machines (VMs)) at the same time; (3) network-based services, which appear to be provided by real server hardware, and are in fact served up by virtual hardware (e.g., virtual servers), simulated by software running on one or more real machines (e.g., allowing to be moved around and scaled up (or down) on the fly without affecting the end user).

In some embodiments, the exemplary inventive computer-based systems/platforms, the exemplary inventive computer-based devices, and/or the exemplary inventive computer-based components of the present disclosure may be configured to securely store and/or transmit data by utilizing one or more of encryption techniques (e.g., private/public key pair, Triple Data Encryption Standard (3DES), block cipher algorithms (e.g., IDEA, RC2, RC5, CAST and Skipjack), cryptographic hash algorithms (e.g., MD5, RIPEMD-160, RTRO, SHA-1, SHA-2, Tiger (TTH), WHIRLPOOL, RNGs).

The aforementioned examples are, of course, illustrative and not restrictive.

As used herein, the term “user” shall have a meaning of at least one user. In some embodiments, the terms “user”, “subscriber” “consumer” or “customer” should be understood to refer to a user of an application or applications for implementing the functions of the CVCP as described herein and/or a consumer of data supplied by a data provider. By way of example, and not limitation, the terms “user” or “subscriber” can refer to a person who receives data provided by the data or service provider over the Internet in a browser session, or can refer to an automated software application which receives the data and stores or processes the data.

In some embodiments, exemplary inventive computer-based systems/platforms, exemplary inventive computer-based devices, and/or exemplary inventive computer-based components of the present disclosure may be configured to handle numerous concurrent users via the N user devices that may be, but is not limited to, at least 100 (e.g., but not limited to, 100-999), at least 1,000 (e.g., but not limited to, 1,000-9,999), at least 10,000 (e.g., but not limited to, 10,000-99,999), at least 100,000 (e.g., but not limited to, 100,000-999,999), at least 1,000,000 (e.g., but not limited to, 1,000,000-9,999,999), at least 10,000,000 (e.g., but not limited to, 10,000,000-99,999,999), at least 100,000,000 (e.g., but not limited to, 100,000,000-999,999,999), at least 1,000,000,000 (e.g., but not limited to, 1,000,000,000-999,999,999,999), and so on.

The aforementioned examples are, of course, illustrative and not restrictive.

In some embodiments, the exemplary inventive computer-based systems, the exemplary inventive computer-based devices, and/or the exemplary inventive computer-based components of the present disclosure may be configured to utilize one or more exemplary AI/machine learning techniques chosen from, but not limited to, decision trees, boosting, support-vector machines, neural networks, nearest neighbor algorithms, Naive Bayes, bagging, random forests, and the like. In some embodiments and, optionally, in combination of any embodiment described above or below, an exemplary neutral network technique may be one of, without limitation, feedforward neural network, radial basis function network, recurrent neural network, convolutional network (e.g., U-net) or other suitable network. In some embodiments and, optionally, in combination of any embodiment described above or below, an exemplary implementation of Neural Network may be executed as follows:
i) Define Neural Network architecture/model,
ii) Transfer the input data to the exemplary neural network model,
iii) Train the exemplary model incrementally,
iv) determine the accuracy for a specific number of timesteps,
v) apply the exemplary trained model to process the newly-received input data,
vi) optionally and in parallel, continue to train the exemplary trained model with a predetermined periodicity.

In some embodiments and, optionally, in combination of any embodiment described above or below, the exemplary trained neural network model may specify a neural network by at least a neural network topology, a series of activation functions, and connection weights. For example, the topology of a neural network may include a configuration of nodes of the neural network and connections between such nodes. In some embodiments and, optionally, in combination of any embodiment described above or below, the exemplary trained neural network model may also be specified to include other parameters, including but not limited to, bias values/functions and/or aggregation functions. For example, an activation function of a node may be a step function, sine function, continuous or piecewise linear function, sigmoid function, hyperbolic tangent function, or other type of mathematical function that represents a threshold at which the node may be activated. In some embodiments and, optionally, in combination of any embodiment described above or below, the exemplary aggregation function may be a mathematical function that combines (e.g., sum, product, etc.) input signals to the node. In some embodiments and, optionally, in combination of any embodiment described above or below, an output of the exemplary aggregation function may be used as input to the exemplary activation function. In some embodiments and, optionally, in combination of any embodiment described above or below, the bias may be a constant value or function that may be used by the aggregation function and/or the activation function to make the node more or less likely to be activated.

At least some aspects of the present disclosure will now be described with reference to the following numbered clauses.

Clause 1. A computer-based method comprising: receiving, by at least one computing device, an original dataset comprising a plurality of original features and a ground truth; crossing over, by the at least one computing device, the plurality of original features to generate a plurality of current features to form a current generation synthesized dataset; generating, by the at least one computing device, at least one subsequent generation synthesized datasets, by: calculating a current importance score of each of the plurality of current features in reference to the ground truth to form a plurality of current importance scores; identifying a current fitness score of the current generation synthesized dataset from the plurality of current importance scores; utilizing a computation resource utilization machine learning model to calculate a plurality of computation resource utilization metrics based on at least one computation cost function of the current generation synthesized dataset, wherein the plurality of computation resource utilization metrics comprises: a first computation resource utilization metric, identifying a parent-pool size, a second computation resource utilization metric, identifying a population size, and a third computation resource utilization metric, identifying a mutation rate for generating a plurality of subsequent features; determining a first number of current features having highest current importance scores among the plurality of current features to identify a plurality of current parent features, the first number being the parent-pool size; crossing over, based on the mutation rate, the plurality of current parent features to generate a second number of subsequent features to form the at least one subsequent generation synthesized dataset, the second number being the population size; iterating, by the at least one computing device, the generating of the at least one subsequent generation synthesized dataset to generate a plurality of subsequent generation synthesized datasets until a plurality of subsequent fitness scores of a predetermined number of consecutive generations of the subsequent generations synthesized datasets stop rising, wherein in each iteration of the generating of the at least one subsequent generation synthesized dataset, a subsequent generation synthesized dataset of an immediately preceding iteration becomes a new current generation dataset for a current iteration; and adding, by the at least one computing device, the plurality of parent features of the plurality of subsequent generations synthesized datasets to the original dataset to form an enhanced dataset.

Clause 2. The method according to clause 1, wherein the crossing over involves multiplying two or more features.

Clause 3. The method according to clause 1, where the current importance score of each of the plurality of current features is calculated from a correlation coefficient between a feature corresponding to the current importance score and the ground truth.

Clause 4. The method according to clause 1, where the current importance score is calculated using a gradient boosting model.

Clause 5. The method according to clause 1, where the current fitness score is identified as a top one of the plurality of current importance scores.

Clause 6. The method according to clause 1, where the computation resource utilization machine learning model is a contextual bandits model.

Clause 7. The method according to clause 1, where each of the plurality of computation resource utilization metrics is stored in a variable which is updated after each iteration.

Clause 8. The method according to clause 1, where the at least one computation cost function of the current generation synthesized dataset is calculated as an amount of time for a run of the current generation's computation in hours minus a difference between a top synthetic feature's importance score of the current generation and a top synthetic feature's importance score of an immediately preceding generation.

Clause 9. The method according to clause 1, further comprising sorting features in the enhanced dataset according to importance scores of the features.

Clause 10. The method according to clause 1, where the at least one computing device includes a plurality of computing nodes parallelly performing the crossings to generate the plurality of current features.

Clause 11. A system, comprising: a plurality of processors; and at least one memory storing a plurality of computing instructions configured to instruct at least one of the plurality of processors to: receive an original dataset comprising a plurality of original features and a ground truth; cross over, by the at least one of the plurality of processors, the plurality of original features to generate a plurality of current features to form a current generation synthesized dataset; generate at least one subsequent generation synthesized datasets, by: calculating a current importance score of each of the plurality of current features in reference to the ground truth to form a plurality of current importance scores; identifying a current fitness score of the current generation synthesized dataset from the plurality of current importance scores; utilizing a computation resource utilization machine learning model to calculate a plurality of computation resource utilization metrics based on at least one computation cost function of the current generation synthesized dataset, wherein the plurality of computation resource utilization metrics comprises: a first computation resource utilization metric, identifying a parent-pool size, a second computation resource utilization metric, identifying a population size, and a third computation resource utilization metric, identifying a mutation rate for generating a plurality of subsequent features; determining a first number of current features having highest current importance scores among the plurality of current features to identify a plurality of current parent features, the first number being the parent-pool size; crossing over, based on the mutation rate, the plurality of current parent features to generate a second number of subsequent features to form the at least one subsequent generation synthesized dataset, the second number being the population size; iterate the generating of the at least one subsequent generation synthesized dataset to generate a plurality of subsequent generation synthesized datasets until a plurality of subsequent fitness scores of a predetermined number of consecutive generations of the subsequent generations synthesized datasets stop rising, wherein in each iteration of the generating of the at least one subsequent generation synthesized dataset, a subsequent generation synthesized dataset of an immediately preceding iteration becomes a new current generation dataset for a current iteration; and add the plurality of parent features of the plurality of subsequent generations synthesized datasets to the original dataset to form an enhanced dataset.

Clause 12. The system according to clause 11, wherein the crossing over involves multiplying two or more features.

Clause 13. The system according to clause 11, where the current importance score of each of the plurality of current features is calculated from a correlation coefficient between a feature corresponding to the current importance score and the ground truth.

Clause 14. The system according to clause 11, where the current importance score is calculated using a gradient boosting model.

Clause 15. The system according to clause 11, where the current fitness score is identified as a top one of the plurality of current importance scores.

Clause 16. The system according to clause 11, where the computation resource utilization machine learning model is a contextual bandits model.

Clause 17. The system according to clause 11, where each of the plurality of computation resource utilization metrics is stored in a variable which is updated after each iteration.

Clause 18. The system according to clause 11, where the at least one computation cost function of the current generation synthesized dataset is calculated as an amount of time for a run of the current generation's computation in hours minus a difference between a top synthetic feature's importance score of the current generation and a top synthetic feature's importance score of an immediately preceding generation.

Clause 19. The system according to clause 11, wherein the plurality of computing instructions are further configured to instruct the at least one of the plurality of processors to sort features in the enhance dataset according to importance scores of the features.

Clause 20. A computer-based method comprising: receiving, by at least one computing device, an original dataset comprising a plurality of original features and a ground truth; crossing over, by the at least one computing device, the plurality of original features to generate a plurality of current features to form a current generation synthesized dataset; generating, by the at least one computing device, at least one subsequent generation synthesized datasets, by: calculating a current importance score of each of the plurality of current features in reference to the ground truth to form a plurality of current importance scores; identifying a current fitness score of the current generation synthesized dataset from the plurality of current importance scores; utilizing a computation resource utilization machine learning model to calculate a plurality of computation resource utilization metrics based on at least one computation cost function of the current generation synthesized dataset, wherein the plurality of computation resource utilization metrics comprises: a first computation resource utilization metric, identifying a parent-pool size, a second computation resource utilization metric, identifying a population size, and a third computation resource utilization metric, identifying a mutation rate for generating a plurality of subsequent features; determining a first number of current features having highest current importance scores among the plurality of current features to identify a plurality of current parent features, the first number being the parent-pool size; crossing over, based on the mutation rate, the plurality of current parent features to generate a second number of subsequent features to form the at least one subsequent generation synthesized dataset, the second number being the population size; iterating, by the at least one computing device, the generating of the at least one subsequent generation synthesized dataset to generate a plurality of subsequent generation synthesized datasets until a plurality of subsequent fitness scores of a predetermined number of consecutive generations of the subsequent generations synthesized datasets stop rising, wherein in each iteration of the generating of the at least one subsequent generation synthesized dataset, a subsequent generation synthesized dataset of an immediately preceding iteration becomes a new current generation dataset for a current iteration; adding, by the at least one computing device, the plurality of parent features of the plurality of subsequent generations synthesized datasets to the original dataset to form an enhanced dataset; and sorting, by the at least one computing device, features in the enhanced dataset according to importance scores of the features.

While one or more embodiments of the present disclosure have been described, it may be understood that these embodiments are illustrative only, and not restrictive, and that many modifications may become apparent to those of ordinary skill in the art, including that various embodiments of the inventive methodologies, the illustrative systems and platforms, and the illustrative devices described herein can be utilized in any combination with each other. Further still, the various steps may be carried out in any desired order (and any desired steps may be added and/or any desired steps may be eliminated).

1. A computer-based method comprising:
receiving, by at least one computing device, an original dataset comprising a plurality of original features and a ground truth;
crossing over, by the at least one computing device, the plurality of original features to generate a plurality of current features to form a current generation synthesized dataset;
generating, by the at least one computing device, at least one subsequent generation synthesized datasets, by:
calculating a current importance score of each of the plurality of current features in reference to the ground truth to form a plurality of current importance scores;
identifying a current fitness score of the current generation synthesized dataset from the plurality of current importance scores;
utilizing a computation resource utilization machine learning model to calculate a plurality of computation resource utilization metrics based on at least one computation cost function of the current generation synthesized dataset, wherein the plurality of computation resource utilization metrics comprises:
a first computation resource utilization metric, identifying a parent-pool size,
a second computation resource utilization metric, identifying a population size, and
a third computation resource utilization metric, identifying a mutation rate for generating a plurality of subsequent features;
determining a first number of current features having highest current importance scores among the plurality of current features to identify a plurality of current parent features, the first number being the parent-pool size;
crossing over, based on the mutation rate, the plurality of current parent features to generate a second number of subsequent features to form the at least one subsequent generation synthesized dataset, the second number being the population size;
iterating, by the at least one computing device, the generating of the at least one subsequent generation synthesized dataset to generate a plurality of subsequent generation synthesized datasets until a plurality of subsequent fitness scores of a predetermined number of consecutive generations of the subsequent generations synthesized datasets stop rising, wherein in each iteration of the generating of the at least one subsequent generation synthesized dataset, a subsequent generation synthesized dataset of an immediately preceding iteration becomes a new current generation dataset for a current iteration; and
adding, by the at least one computing device, the plurality of parent features of the plurality of subsequent generations synthesized datasets to the original dataset to form an enhanced dataset.

2. The method according to claim 1, wherein the crossing over involves multiplying two or more features.

3. The method according to claim 1, where the current importance score of each of the plurality of current features is calculated from a correlation coefficient between a feature corresponding to the current importance score and the ground truth.

4. The method according to claim 1, where the current importance score is calculated using a gradient boosting model.

5. The method according to claim 1, where the current fitness score is identified as a top one of the plurality of current importance scores.

6. The method according to claim 1, where the computation resource utilization machine learning model is a contextual bandits model.

7. The method according to claim 1, where each of the plurality of computation resource utilization metrics is stored in a variable which is updated after each iteration.

8. The method according to claim 1, where the at least one computation cost function of the current generation synthesized dataset is calculated as an amount of time for a run of the current generation's computation in hours minus a difference between a top synthetic feature's importance score of the current generation and a top synthetic feature's importance score of an immediately preceding generation.

9. The method according to claim 1, further comprising sorting features in the enhanced dataset according to importance scores of the features.

10. The method according to claim 1, where the at least one computing device includes a plurality of computing nodes parallelly performing the crossings to generate the plurality of current features.

11. A system, comprising:
a plurality of processors; and
at least one memory storing a plurality of computing instructions configured to instruct at least one of the plurality of processors to:
receive an original dataset comprising a plurality of original features and a ground truth;
cross over, by the at least one of the plurality of processors, the plurality of original features to generate a plurality of current features to form a current generation synthesized dataset;
generate at least one subsequent generation synthesized datasets, by:
calculating a current importance score of each of the plurality of current features in reference to the ground truth to form a plurality of current importance scores;
identifying a current fitness score of the current generation synthesized dataset from the plurality of current importance scores;
utilizing a computation resource utilization machine learning model to calculate a plurality of computation resource utilization metrics based on at least one computation cost function of the current generation synthesized dataset, wherein the plurality of computation resource utilization metrics comprises:
a first computation resource utilization metric, identifying a parent-pool size,
a second computation resource utilization metric, identifying a population size, and
a third computation resource utilization metric, identifying a mutation rate for generating a plurality of subsequent features;
determining a first number of current features having highest current importance scores among the plurality of current features to identify a plurality of current parent features, the first number being the parent-pool size;
crossing over, based on the mutation rate, the plurality of current parent features to generate a second number of subsequent features to form the at least one subsequent generation synthesized dataset, the second number being the population size;
iterate the generating of the at least one subsequent generation synthesized dataset to generate a plurality of subsequent generation synthesized datasets until a plurality of subsequent fitness scores of a predetermined number of consecutive generations of the subsequent generations synthesized datasets stop rising, wherein in each iteration of the generating of the at least one subsequent generation synthesized dataset, a subsequent generation synthesized dataset of an immediately preceding iteration becomes a new current generation dataset for a current iteration; and
add the plurality of parent features of the plurality of subsequent generations synthesized datasets to the original dataset to form an enhanced dataset.

12. The system according to claim 11, wherein the crossing over involves multiplying two or more features.

13. The system according to claim 11, where the current importance score of each of the plurality of current features is calculated from a correlation coefficient between a feature corresponding to the current importance score and the ground truth.

14. The system according to claim 11, where the current importance score is calculated using a gradient boosting model.

15. The system according to claim 11, where the current fitness score is identified as a top one of the plurality of current importance scores.

16. The system according to claim 11, where the computation resource utilization machine learning model is a contextual bandits model.

17. The system according to claim 11, where each of the plurality of computation resource utilization metrics is stored in a variable which is updated after each iteration.

18. The system according to claim 11, where the at least one computation cost function of the current generation synthesized dataset is calculated as an amount of time for a run of the current generation's computation in hours minus a difference between a top synthetic feature's importance score of the current generation and a top synthetic feature's importance score of an immediately preceding generation.

19. The system according to claim 11, wherein the plurality of computing instructions are further configured to instruct the at least one of the plurality of processors to sort features in the enhance dataset according to importance scores of the features.

20. A computer-based method comprising:
receiving, by at least one computing device, an original dataset comprising a plurality of original features and a ground truth;
crossing over, by the at least one computing device, the plurality of original features to generate a plurality of current features to form a current generation synthesized dataset;
generating, by the at least one computing device, at least one subsequent generation synthesized datasets, by:
calculating a current importance score of each of the plurality of current features in reference to the ground truth to form a plurality of current importance scores;
identifying a current fitness score of the current generation synthesized dataset from the plurality of current importance scores;
utilizing a computation resource utilization machine learning model to calculate a plurality of computation resource utilization metrics based on at least one computation cost function of the current generation synthesized dataset, wherein the plurality of computation resource utilization metrics comprises:
a first computation resource utilization metric, identifying a parent-pool size,
a second computation resource utilization metric, identifying a population size, and
a third computation resource utilization metric, identifying a mutation rate for generating a plurality of subsequent features;
determining a first number of current features having highest current importance scores among the plurality of current features to identify a plurality of current parent features, the first number being the parent-pool size;
crossing over, based on the mutation rate, the plurality of current parent features to generate a second number of subsequent features to form the at least one subsequent generation synthesized dataset, the second number being the population size;
iterating, by the at least one computing device, the generating of the at least one subsequent generation synthesized dataset to generate a plurality of subsequent generation synthesized datasets until a plurality of subsequent fitness scores of a predetermined number of consecutive generations of the subsequent generations synthesized datasets stop rising, wherein in each iteration of the generating of the at least one subsequent generation synthesized dataset, a subsequent generation synthesized dataset of an immediately preceding iteration becomes a new current generation dataset for a current iteration;
adding, by the at least one computing device, the plurality of parent features of the plurality of subsequent generations synthesized datasets to the original dataset to form an enhanced dataset; and
sorting, by the at least one computing device, features in the enhanced dataset according to importance scores of the features.
